(19) United States
(12) Patent Application Publication
(10) Pub. No.: US 2022/0397079 A1
(43) Pub. Date: Dec. 15, 2022

(54) INTEGRATED PROPULSION SYSTEM FOR HYBRID ROCKETS

(71) Applicant: AT SPACE PTY LTD, North Adelaide (AU)

(72) Inventor: Yen-Sen CHEN, North Adelaide (AU)

(21) Appl. No.: 17/343,739

(22) Filed: Jun. 10, 2021

(51) Int. Cl. F02K 9/52; F02K 9/60

(52) U.S. Cl. CPC F02K 9/52; F02K 9/60

(57) ABSTRACT

An integrated propulsion system for hybrid rockets includes an oxidizer tank, a rocket engine, a pressurization device, a pressurization device and an oxidizer pipe and valve unit. The rocket engine is disposed within the oxidizer tank partially and located on a first side of the oxidizer tank. The pressurization device is disposed, at least in part, within the oxidizer tank, is located on a second side of the oxidizer tank opposite to the first side of the oxidizer tank, and is configured to regulate an overall pressure level within the oxidizer tank. The oxidizer pipe and valve unit is connected to the oxidizer tank and the rocket engine, and is configured to control feeding of an oxidizer from the oxidizer tank into the rocket engine.

### BACKGROUND

### Field of the Invention

The present invention relates to a rocket propulsion system, and more particularly to an integrated propulsion system for hybrid rockets.

### Description of Related Art

Conventional hybrid rocket propulsion systems consist of an oxidizer tank holding liquid or gaseous oxidizer, an oxidizer mass flow pipe and valve system, and a solid fuel motor consisting of an injector, a combustion chamber holding segments of solid fuel, and a convergent-divergent nozzle commonly made of heat resistant composite materials. Typically, the solid fuel motor is disposed outside the oxidizer tank. Although it is simple for the technical personnel in the art to externally assemble the solid fuel motor to the oxidizer tank, such a hybrid rocket propulsion system's overall structural mass fraction is usually not optimized for better rocket performance, and the composite nozzle is limited in system burn time length due to higher nozzle regression rates compared to traditional solid rocket nozzles.

### SUMMARY

One objective of the present invention is to provide an integrated propulsion system for hybrid rockets that loses its weight as far as possible while achieving better rocket performance.

Another objective of the present invention is to provide an integrated propulsion system for hybrid rockets that possibly prevents the nozzle of the rocket engine from nozzle erosion.

Yet another objective of the present invention is to provide an integrated propulsion system for hybrid rockets that possibly lengthens the system burn time thereof.

To achieve one or more of the forementioned objectives, the present invention provides an integrated propulsion system according to an embodiment, which is adapted to be installed in a hybrid rocket and includes an oxidizer tank, a rocket engine, a pressurization device, a pressurization device and an oxidizer pipe and valve unit. The rocket engine is disposed within the oxidizer tank partially and located on a first side of the oxidizer tank. The pressurization device is disposed, at least in part, within the oxidizer tank, and located on a second side of the oxidizer tank opposite to the first side of the oxidizer tank. The pressurization device is configured to regulate an overall pressure level within the oxidizer tank. The oxidizer pipe and valve unit is connected to the oxidizer tank and the rocket engine, and is configured to control feeding of an oxidizer from the oxidizer tank into the rocket engine.

In some embodiments, the oxidizer tank includes a first tank casing, the rocket engine includes an engine casing having an average thickness thinner than an average thickness of the first tank casing.

In some embodiments, the oxidizer tank includes a first tank casing and a pressurization device, the pressurization device includes a pressurization tank comprising a second tank casing having an average thickness that is thinner than an average thickness of the first tank casing.

In some embodiments, the rocket engine includes an oxidizer injector, a combustion chamber, and a nozzle, and the oxidizer injector is closer to the pressurization device than the nozzle.

In some embodiments, the pressurization device includes a pressurization tank and a pressurization control valve, the pressurization tank is located within the oxidizer tank, and the pressurization control valve is disposed to the oxidizer tank and connected to the pressurization tank.

In some embodiments, the oxidizer pipe and valve unit includes an oxidizer feeding pipe and an oxidizer filling control valve, the oxidizer feeding pipe connects the oxidizer tank to the rocket engine for the feeding of the oxidizer, and the oxidizer filling control valve is disposed to the oxidizer feeding pipe and configured to selectively enable the feeding of the oxidizer in the oxidizer feeding pipe toward a combustion chamber of the rocket engine.

In some embodiments, the oxidizer pipe and valve unit further includes at least one liquid injection thrust vector control (LITVC) valve disposed to the oxidizer feeding pipe and configured to selectively enable the feeding of the oxidizer in the oxidizer feeding pipe toward a nozzle of the rocket engine.

In some embodiments, the integrated propulsion system further includes a cooling device disposed to the rocket engine and configured to thermally protect the rocket engine.

In some embodiments, the cooling device includes a coolant chamber surrounding the rocket engine and communicated with a feeding channel of the oxidizer pipe and valve unit and a combustion chamber of the rocket engine, so that the oxidizer flows from the oxidizer tank to the combustion chamber through the feeding channel and the coolant chamber.

In some embodiments, the oxidizer tank is made of a filament wound carbon fiber composite material.

### BRIEF DESCRIPTION OF THE DRAWINGS

After studying the detailed description in conjunction with the following drawings, other aspects and advantages of the present invention will be discovered:

FIG. 1 is a schematic diagram of an integrated propulsion system installed in a hybrid rocket according to an embodiment of the present invention; and

FIG. 2 is an enlarged view of a part of the propulsion system in FIG. 1 according to an embodiment of the present invention.

### DETAILED DESCRIPTION

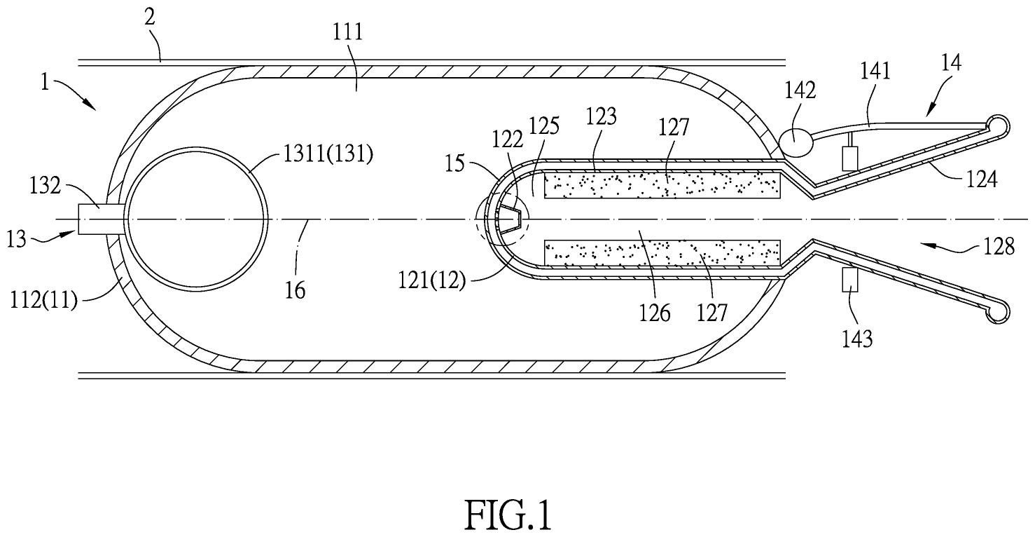

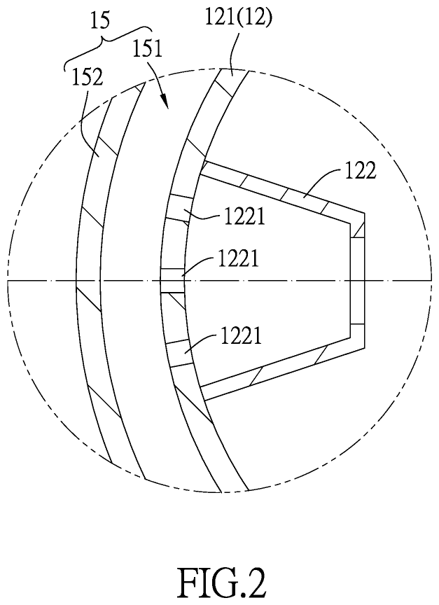

Please refer to FIGS. 1 and 2 showing an integrated propulsion system 1 provided according to an embodiment of the present invention. The propulsion system 1 is suitable for being installed in an inner space of a hybrid rocket so that a rocket casing 2 of the hybrid rocket can protect the propulsion system 1. The propulsion system 1 mainly includes an oxidizer tank 11, a rocket engine 12, a pressurization device 13, an oxidizer pipe and valve unit 14 and a cooling device 15.

The oxidizer tank 11 is made of a filament wound carbon fiber composite material. The oxidizer tank 11 has an inner space 111 for being filled with a liquid or gaseous oxidizer and accommodating at least a part of the rocket engine 12, at least a part of the pressurization device 13, and at least a part of the cooling device 15. The rocket engine 12 and the pressurization device 13 are located on the two opposite sides (i.e., the first and second sides) of the oxidizer tank 11.

The rocket engine 12 includes an engine casing 121, an oxidizer injector 122 in an injection zone thereof, a combustion chamber 123 in a chamber zone thereof, and a nozzle 124 in a nozzle zone thereof. The combustion chamber 123 is connected to the oxidizer injector 122, a first end of the nozzle 124 is far from the combustion chamber 123, and a second end of the nozzle 124 is opposite to the first end of the nozzle 124 and is connected to the combustion chamber 123. In the embodiment, the oxidizer injector 122, the combustion chamber 123 and the nozzle 124 are located in the inner space 125 of the engine casing 121; and the output space 128 of the nozzle 124 is communicated with the inner space 125. Moreover, the oxidizer injector 122 and the combustion chamber 123 are located inside the oxidizer tank 11, the nozzle 124 is located outside the oxidizer tank 11, and the combustion chamber 123 is located between the oxidizer injector 122 and the nozzle 124. The main portion of the combustion chamber 123 is formed as a cylindrical tube, in which one or more combustion channels 126 and a solid fuel 127 surrounding the one or more combustion channels 126 are disposed. The respective combustion channel 126 extending along the geometric central axis 16 of the propulsion system 1 is used for the flowing of the oxidizer. The solid fuel 127 is close to or attached to the inner surface of the engine casing 121 in the chamber zone and is used for reacting with the oxidizer passing through the combustion channel 126.

The pressurization device 13 is closer to the oxidizer injector 122 but far from the nozzle 124, and includes a pressurization tank 131 and a pressurization control valve 132. The pressurization tank 131 is mounted to the first tank casing 112 of the oxidizer tank 11 and located in the inner space 111 of the oxidizer tank 11. The pressurization control valve 132 is mounted to the first tank casing 112 of the oxidizer tank 11 and has a part located outside the oxidizer tank 11. The pressurization control valve 132 is connected to the pressurization tank 131 so that the pressurization control valve 132 is capable of operatively regulating an overall pressure level within the oxidizer tank 11 by filling gas into the pressurization tank 131 or draining gas from the pressurization tank 131.

The oxidizer pipe and valve unit 14 includes an oxidizer feeding pipe 141, an oxidizer filling control valve 142 and one or more LITVC valves 143. The oxidizer feeding pipe 141 is connected to the oxidizer tank 11, the rocket engine 12 and the cooling device 15. The oxidizer filling control valve 142 and the LITVC valve 143 are disposed to the oxidizer feeding pipe 141. The oxidizer filling control valve 142 controls the enabling or disabling of the feeding channel of the oxidizer feeding pipe 141 for the flowing of the high-pressure oxidizer from the oxidizer tank 11 to the combustion chamber 123 of the rocket engine 12 through the cooling device 15. The LITVC valve 143 controls the enabling or disabling of the branch of the oxidizer feeding pipe 141 for the flowing of the high-pressure oxidizer from the oxidizer tank 11 to the output space 128 of the nozzle 124 of the rocket engine 12.

The cooling device 15 is, for example, a regenerative cooling mechanism, is disposed (connected) to the rocket engine 12 by covering on the oxidizer injector 122, the combustion chamber 123 and the nozzle 124, for thermally protecting the rocket engine 12, and is also connected to the oxidizer pipe and valve unit 14. Specifically, as shown in FIGS. 1 and 2, the oxidizer feeding pipe 141 is connected to the cooling device 15 at the first end of the nozzle 124, and the cooling device 15 includes a coolant chamber 151 surrounding the rocket engine 12. The wall 152 of the cooling device 15 and the engine casing 121 of the rocket engine 12 form together the coolant chamber 151 therebetween, and the coolant chamber 151 covers a part or all of the outer surface of the engine casing 121 of the rocket engine 12, so that the coolant chamber 151 gets past the oxidizer injector 122, the combustion chamber 123 and the nozzle 124. The coolant chamber 151 serves as a coolant channel communicated with the feeding channel of the oxidizer feeding pipe 141 operatively, and communicated with the combustion chamber 123 of the rocket engine 12 through the through holes 1221 of the oxidizer injector 122 for the flowing of the oxidizer toward the combustion chamber 123.

Through the foregoing structure, the oxidizer contained in the oxidizer tank 11 is allowable to flow to the combustion chamber 123 through the feeding channel and the coolant chamber 151 when the oxidizer filling control valve 142 enables the feeding channel of the oxidizer feeding pipe 141. Since the coolant chamber 151 spreads on the outer surface of the rocket engine 12, the outer surface of the rocket engine 12 within the oxidizer tank 11 and the outer surface of the rocket engine 12 outside the oxidizer tank 11 both are possibly cooled through the high-pressure oxidizer outputted from the oxidizer tank 11 and flowing in the coolant chamber 151. The cooling device 15 possibly protects the rocket engine 12 from thermal damage. In particular, the coolant chamber 151 of the cooling device 15 extends from the first end of the nozzle 124 to the second end of the nozzle 124 so that the oxidizer fed by the oxidizer pipe and valve unit 14 and flowing within the coolant chamber 151 can flow past the first end of the nozzle 124 to the second end of the nozzle 124 to cool the nozzle 124 and protect the nozzle 124 from nozzle erosion, thereby possibly reducing the nozzle regression rate. Further, the oxidizer contained in the oxidizer tank 11 is also allowable to flow to the output space 128 of the nozzle 124 through the branch when the LITVC valve 143 enables the branch, thereby lengthening the system burn time.

On the other hand, since the rocket engine 12 is located within and protected by the oxidizer tank 11, it is possible for the engine casing 121 of the rocket engine 12 to be thinned. For example, the engine casing 121 of the rocket engine 12 within the oxidizer tank 11 has an average thickness thinner than the average thickness of the first tank casing 112 of the oxidizer tank 11. Likewise, it is also possible the second tank casing 1311 of the pressurization tank 131 to be thinned. For example, the second tank casing 1311 of the pressurization tank 131 has an average thickness thinner than the average thickness of the first tank casing 112. In this way, the propulsion system 1 would become lighter for a higher propellant mass fraction of a rocket stage, leading to better rocket performance.

While we have shown and described various embodiments in accordance with the present invention, it is clear to those skilled in the art that further embodiments may be made without departing from the scope of the present invention.

1. An integrated propulsion system of a hybrid rocket, comprising:
an oxidizer tank comprising a first tank casing;
a rocket engine, located on a first side of the oxidizer tank, and comprising an oxidizer injector, a combustion chamber and a nozzle, the oxidizer injector and the combustion chamber being arranged inside the first tank casing, and the combustion chamber being located between and connected to the oxidizer injector and the nozzle;
a pressurization device, disposed, at least in part, inside the first tank casing, located on a second side of the oxidizer tank opposite to the first side of the oxidizer tank, and configured to regulate an overall pressure level within the oxidizer tank; and
an oxidizer pipe and valve unit, arranged outside the first tank casing, connected to the first tank casing and the rocket engine, and configured to control feeding of an oxidizer from the oxidizer tank into the rocket engine,
wherein the oxidizer injector and the combustion chamber are located between the pressurization device and the oxidizer pipe and valve unit.

2. The integrated propulsion system according to claim 1, wherein the rocket engine comprises an engine casing having an average thickness thinner than an average thickness of the first tank casing.

3. The integrated propulsion system according to claim 1, wherein the pressurization device comprises a pressurization tank comprising a second tank casing having an average thickness that is thinner than an average thickness of the first tank casing.

4. The integrated propulsion system according to claim 1, wherein the oxidizer injector is closer to the pressurization device than the nozzle.

5. The integrated propulsion system according to claim 1, wherein the pressurization device comprises a pressurization tank and a pressurization control valve, the pressurization tank is located inside the first tank casing, and the pressurization control valve is connected to the first tank casing and connected to the pressurization tank.

6. The integrated propulsion system according to claim 1, wherein the oxidizer pipe and valve unit comprises an oxidizer feeding pipe and an oxidizer filling control valve, the oxidizer feeding pipe connects the oxidizer tank to the rocket engine for the feeding of the oxidizer, and the oxidizer filling control valve is connected to the oxidizer feeding pipe and configured to selectively enable the feeding of the oxidizer in the oxidizer feeding pipe toward the combustion chamber of the rocket engine.

7. The integrated propulsion system according to claim 6, wherein the oxidizer pipe and valve unit further comprises at least one liquid injection thrust vector control (LITVC) valve connected to the oxidizer feeding pipe and configured to selectively enable the feeding of the oxidizer in the oxidizer feeding pipe toward the nozzle of the rocket engine.

8. The integrated propulsion system according to claim 1, further comprising a cooling device connected to the rocket engine and configured to thermally protect the rocket engine.

9. The integrated propulsion system according to claim 8, wherein the cooling device comprises a coolant chamber surrounding the rocket engine and communicated with a feeding channel of the oxidizer pipe and valve unit and the combustion chamber of the rocket engine, so that the oxidizer flows from the oxidizer tank to the combustion chamber through the feeding channel and the coolant chamber.

10. The integrated propulsion system according to claim 1, wherein the oxidizer tank is made of a filament wound carbon fiber composite material.

11. An integrated propulsion system of a hybrid rocket, comprising:
an oxidizer tank comprising a first tank casing;
a rocket engine, located on a first side of the oxidizer tank, and comprising an oxidizer injector, a combustion chamber and a nozzle, the oxidizer injector and the combustion chamber being arranged inside the first tank casing, and the combustion chamber being located between and connected to the oxidizer injector and the nozzle;
a cooling device, connected to the rocket engine and configured to thermally protect the rocket engine;
a pressurization device, disposed, at least in part, inside the first tank casing, located on a second side of the oxidizer tank opposite to the first side of the oxidizer tank, and configured to regulate an overall pressure level within the oxidizer tank; and
an oxidizer pipe and valve unit, arranged outside the first tank casing, connected to the first tank casing and the cooling device at the first end of the nozzle, and configured to control feeding of an oxidizer from the oxidizer tank into the rocket engine,
wherein the oxidizer injector and the combustion chamber are located between the pressurization device and the oxidizer pipe and valve unit, and the cooling device extends from a first end of the nozzle to a second end of the nozzle opposite to the first end of the nozzle and connected to the combustion chamber so that the oxidizer fed by the oxidizer pipe and valve unit flows past the nozzle to cool the nozzle while flowing through the cooling device.

12. The integrated propulsion system according to claim 11, wherein the rocket engine comprises an engine casing having an average thickness thinner than an average thickness of the first tank casing.

13. The integrated propulsion system according to claim 11, wherein the pressurization device comprises a pressurization tank comprising a second tank casing having an average thickness that is thinner than an average thickness of the first tank casing.

14. The integrated propulsion system according to claim 11, wherein the oxidizer injector is closer to the pressurization device than the nozzle.

15. The integrated propulsion system according to claim 11, wherein the pressurization device comprises a pressurization tank and a pressurization control valve, the pressurization tank is located inside the first tank casing, and the pressurization control valve is connected to the first tank casing and connected to the pressurization tank.

16. The integrated propulsion system according to claim 11, wherein the oxidizer pipe and valve unit comprises an oxidizer feeding pipe and an oxidizer filling control valve, the oxidizer feeding pipe connects the oxidizer tank to the rocket engine for the feeding of the oxidizer, and the oxidizer filling control valve is connected to the oxidizer feeding pipe and configured to selectively enable the feeding of the oxidizer in the oxidizer feeding pipe toward the combustion chamber of the rocket engine.

17. The integrated propulsion system according to claim 16, wherein the oxidizer pipe and valve unit further comprises at least one liquid injection thrust vector control (LITVC) valve connected to the oxidizer feeding pipe and configured to selectively enable the feeding of the oxidizer in the oxidizer feeding pipe toward the nozzle of the rocket engine.

18. The integrated propulsion system according to claim 11, wherein the cooling device comprises a coolant chamber surrounding the rocket engine and communicated with a feeding channel of the oxidizer pipe and valve unit and the combustion chamber of the rocket engine, so that the oxidizer flows from the oxidizer tank to the combustion chamber through the feeding channel and the coolant chamber.

19. The integrated propulsion system according to claim 11, wherein the oxidizer tank is made of a filament wound carbon fiber composite material.
